(19) United States
(12) Patent Application Publication
(10) Pub. No.: US 2013/0313454 A1
(43) Pub. Date: Nov. 28, 2013

(54) MONITORING OPERATION OF A DC MOTOR VALVE ASSEMBLY

(71) Applicant: Adam Stubbs, Peterborough (GB)

(72) Inventor: Adam Stubbs, Peterborough (GB)

(73) Assignee: Perkins Engines Company Limited, Peterborough (GB)

(21) Appl. No.: 13/984,878

(22) PCT Filed: Feb. 27, 2013
(86) PCT No.: PCT/EP2012/053292

§ 371 Date: Aug. 12, 2013

(30) Foreign Application Priority Data
Feb. 28, 2011 (GB) 1103375.0

(51) Int. Cl. F16K 31/04; F16K 37/00

(52) U.S. Cl. CPC F16K 31/046; F16K 37/0041
USPC 251/129.04; 137/554; 251/129.11

(57) ABSTRACT

A method is provided for monitoring operation of a valve assembly includes a valve element movable between open and closed stops. A position of the valve element between the stops establishes the extent to which the valve is open. The valve assembly includes a DC motor for moving the valve element in response to an electric signal; a position sensor for detecting an actual position of the valve element; and a controller configured to receive data corresponding to a desired position of the valve element, and to supply a calculated electric signal to the motor to move the valve element from the actual position to the desired position. The method comprises: measuring the electric signal output from the controller for input to the motor when the valve element is stationary, and comparing the measured electric signal with a reference electric signal in order to identify a fault.

### TECHNICAL FIELD

Controller and method for operation of a valve assembly.

### BACKGROUND

Valves having DC motor actuators are known for a variety of applications, including in the automotive field. For example, in an engine, a DC motor valve may be used to control the recirculation of exhaust gases back to the engine cylinders in an exhaust gas recirculation (EGR) system.

A DC motor valve comprises a valve element which is movable between a first end in which the valve is fully open and a second end, opposite the first end, in which the valve is fully closed. The position of the valve element between the first end and the second end establishes the extent to which the valve is open. The valve may include a mechanical stop at the first end to prevent the valve element from moving beyond the first end and a mechanical stop at the second end to prevent the valve element from moving beyond the second end.

Applying a current of a first polarity to the DC motor may cause the valve element to move in a first direction, i.e. towards the first end, and applying a current of a second polarity, opposite to the first polarity, to the DC motor may cause the valve element to move in a second direction opposite to the first direction, i.e. towards the second end.

In certain conditions, valves and their associated control systems may behave unexpectedly. It is helpful to be able to confirm regularly during operation that a valve is behaving as expected. Moreover, in the event of unexpected behaviour it is helpful to obtain a rapid and accurate diagnosis of the issue. More accurate diagnosis results in less down time as well as and more rapid and less costly repair.

### SUMMARY OF THE DISCLOSURE

The disclosure provides:

a method for monitoring operation of a valve assembly, the valve assembly comprising:

a valve element movable between an open stop and a closed stop wherein a position of the valve element between the open stop and the closed stop establishes the extent to which the valve is open;

a DC motor for moving the valve element in response to an electric signal;

a position sensor for detecting an actual position of the valve element; and

a controller configured to receive data corresponding to a desired position of the valve element and to supply a calculated electric signal to the DC motor in order to effect movement of the valve element from the actual position of the valve element to the desired position of the valve element;

the method comprising the steps of:

measuring the electric signal output from the controller for input to the DC motor when the valve element is stationary;

comparing the measured electric signal output from the controller with a reference electric signal in order to identify a fault.

The disclosure also provides:

a controller for monitoring operation of a valve assembly, the valve assembly comprising:

a valve element movable between an open stop and a closed stop wherein a position of the valve element between the open stop and the closed stop establishes the extent to which the valve is open;

a DC motor for moving the valve element in response to an electric signal; and

a position sensor for detecting an actual position of the valve element;

the controller comprising:

an electric signal controller configured to receive data corresponding to a desired position of the valve element and to supply an electric signal for input to the DC motor in order to effect movement of the valve element from the actual position of the valve element to the desired position of the valve element;

a position data receiving portion configured to receive valve element position data from the position sensor and determine that the valve element is stationary;

an electric signal comparator configured to compare the electric signal output from the electric signal controller with a reference electric signal in order to identify a fault; and

an indicator configured to indicate whether the electric signal output from the electric signal controller is above or below the reference electric signal.

An embodiment of the invention will now be described, by way of example only, with reference to the accompanying drawing in which:

### BRIEF DESCRIPTION OF THE DRAWING

FIG. 1 is a schematic diagram showing the features of the controller of the present disclosure in the context of a valve actuated by a DC motor.

### DETAILED DESCRIPTION

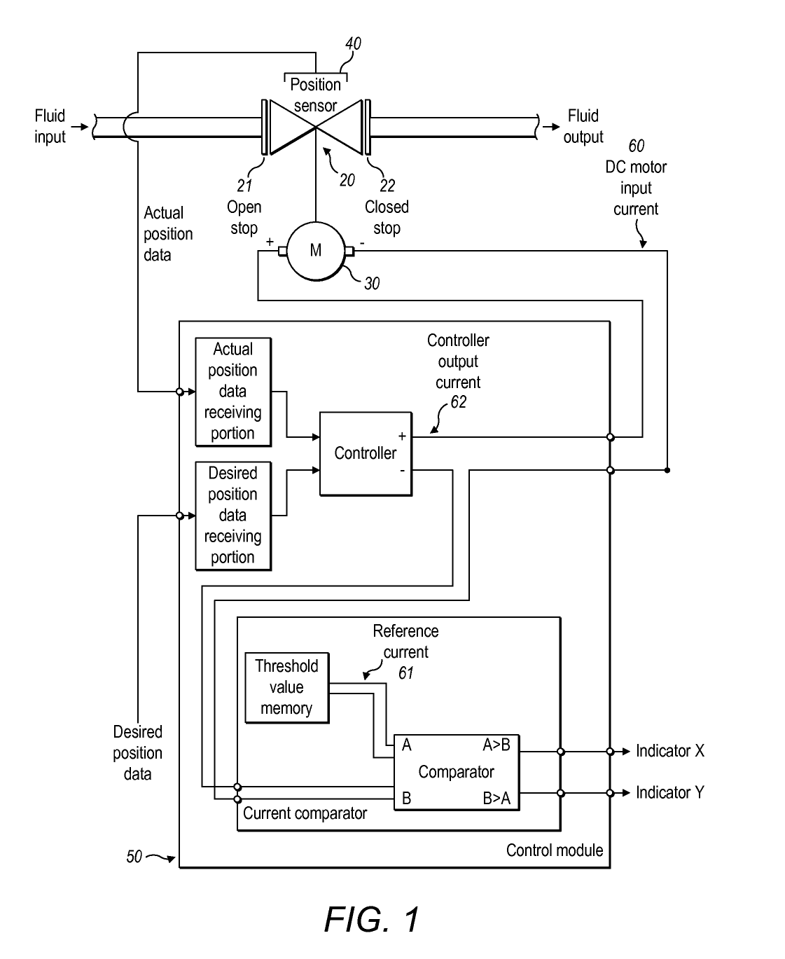

Referring to FIG. 1 there is illustrated a valve assembly 1 comprising a valve element 20, a DC motor 30, a position sensor 40 and a controller 50. The valve element 20 may be movable between an open stop 21 and a closed stop 22. The valve is fully open when the valve element 20 is located at the open stop 21 and the valve is fully closed when the valve element 20 is located at the closed stop 22. The valve element 20 may be positioned between the open stop 21 and the closed stop 22 such that the valve is neither fully open nor fully closed. Where the valve element 20 is neither in the fully open nor in the fully closed position, the position of the valve element 20 relative to the open and closed stops 21, 22 dictates the extent to which the valve is open. The position of the valve element 20 may be sensed by one or more position sensors 40.

The DC motor 30 is arranged to receive a current in order to cause the DC motor 30 to rotate. Current of a first polarity causes the DC motor 30 to rotate in a first direction while current of a second polarity causes the DC motor 30 to rotate in a second direction, opposite to the first direction. Rotational movement of the DC motor 30 may be used to actuate movement of the valve element 20. Rotational movement of the DC motor 30 in a first direction may be used to actuate movement of the valve element 20 in a third direction, i.e. towards the open stop 21, while rotational movement of the DC motor 30 in a second direction may be used to actuate movement of the valve element 20 in a fourth direction, opposite to the third direction, i.e. towards the closed stop 22. By this method, the valve element 20 may be finely positioned to a variety of locations between the open and closed stops 21, 22.

The controller 50 may receive data relating to the desired position of the valve element 20 and may also receive data from the position sensor 40 relating to the actual position of the valve element 20. The controller may then calculate the distance to be moved by the valve element 20 in order to move from the actual position to the desired position. Having calculated this distance, the controller 50 may further calculate the current necessary to supply to the DC motor 30 in order to effect rotation thereof so as to cause movement of the valve element 20 from the actual position to the desired position. The current calculated by the controller 50 (the controller output current 62) may then be input to the DC motor 30 as the DC motor input current 60.

In some embodiments the valve element 20 may be biased towards one of the stops 21, 22 by a spring or other means. For example, it may be sprung biased towards the closed stop 22. In an embodiment having the valve element 20 biased towards the closed stop 22, the valve element 20 will move towards the closed stop 22 when no current is applied to the DC motor 30. Similarly, in an embodiment having the valve element 20 biased towards the open stop 21, the valve element 20 will move towards the open stop 21 when no current is applied to the DC motor 30.

In embodiments where the valve element 20 is biased towards one of the stops 21, 22, when calculating the current necessary to move the valve element 20 against the bias, the controller 50 may take account of the energy needed to overcome the bias.

The controller 50 may comprise a current calculator for calculating the required current and a variable current supply for supplying the current.

In some embodiments, an open circuit check on the circuit supplying current to the DC motor 30 is performed. This open circuit check is performed when the current is likely to be sufficiently trustworthy and steady to provide a reliable reading. As such, the open circuit check may be performed when the valve element 20 is stationary. This is because, to perform the open circuit check when the valve element 20 is moving would necessarily mean performing the open circuit check when the motor 30 is rotating. Moreover, when the motor 30 is rotating, a back EMF (electromotive force) may be generated which may cause current to flow in the circuit. This current may counter any current output by the controller 50 and so may result in a net current reading of approximately zero which might result in an open circuit check triggering a positive indication of an open circuit when, in fact, the circuit may not be open circuit.

The controller 50 may therefore be programmed to perform the open circuit check whenever the valve element is detected to be stationary. It may therefore be that an open circuit check is performed: (i) on start up of a machine or system incorporating a valve having the valve element 20; (ii) when the valve element 20 is against a stop 21, 22; and (iii) when the valve element 20 is stationary and, in particular, when a calculated position of the valve element 20 is different from the actual position of the valve element 20.

The open circuit check may be performed when the valve element 20 is in the valve closed position or the valve open position. This position may be achieved when no current is flowing through the DC motor 30. In order to check for an open circuit error, the controller 50 supplies a current (controller output current 62) to the DC motor 30 in order to bias the valve element 20 towards the stop associated with the instantaneous valve position notwithstanding that the stop prevents movement of the valve element 20 there beyond.

The actual controller output current 62 is then measured. If the controller output current 62 is below a threshold of, for example, 5% of the maximum current which the DC motor 30 can receive in normal operation, then there is assumed to be an open circuit and an appropriate indicator is actuated.

The open circuit check may also be performed in the event that the valve element 20 is located between the open and closed stops 21, 22 and is detected to be stationary notwithstanding the controller 50 outputting a current (controller output current 62) intended to cause the DC motor 30 to rotate and the valve element 20 to move. In this event, the controller output current 62 is non-zero. The controller output current 62 may be compared with a threshold current 61. In the event that the controller output current 62 is less than the threshold current 61 this may indicate an open circuit and a first indicator is used to communicate this to a user. A user is then put on notice to check electrical continuity of the relevant circuit and/or to check the controller 50. On the other hand, in the event that the controller output current 62 is greater than the threshold current 61 this indicates no open circuit and a second indicator is used to communicate this to a user. A user is then put on notice to investigate a possible mechanical fault with the valve assembly.

The open circuit check may be able to eliminate possible reasons for unexpected behaviour and so reduce the time taken by a user to identify the precise cause of unexpected behaviour.

In one specific embodiment, the valve may be used to control the flow of exhaust gas back to the cylinders in an exhaust gas recirculation (EGR) system of an engine. In such a case, the controller 50 may be a part of an engine control module (ECM). The valve may be biased in the closed position (such that in the default position no gas is recirculated). In a specific embodiment, the DC motor valve may be configured to operate with a maximum RMS (root mean square) current value of 1.1 A and with a maximum current value of 12 A. In order to remain within the maximum RMS current value, the maximum 12 A may be applied for a maximum of, for example, 120 ms.

Since the valve defaults to the closed position, the valve is closed on start up of the engine. At this point, an open circuit test may be carried out. This involves having the controller 50 output a current (the controller output current 62) in order to cause the valve element to attempt to move against the closed stop 22. The controller output current 62 may be up to or at the maximum current of 12 A. The controller output current 62 is compared with a threshold current 61. The threshold current value 61 may be 50 mA. This may represent approximately 5% of the expected controller output current 62 value. In the event that the comparison reveals that the controller output current 62 is, in fact, higher than the threshold current 61 then the open circuit test has been passed (i.e. no open circuit is detected). This may or may not be indicated to a user. In the event that the comparison reveals that the controller output current 62 is, in fact, lower than the threshold current 61 then the open circuit test has failed (i.e. open circuit is detected). This may or may not be indicated to a user. Where the result is indicated to a user it may be in such a way as to identify non-specific unexpected behaviour. Alternatively, it may be in such a way as to identify that the circuit is open circuit which will allow the user to identify more accurately which component or components would benefit from further inspection.

An open circuit test may also be performed when the valve element 20 is detected to be stationary at any point between the stops. Given that in the EGR application the valve element 20 may be biased closed, a current may be passed through the DC motor 30 in order for the valve element 20 to remain stationary in any position other than the default position.

When the valve element 20 is detected to be stationary, the open circuit test may be initiated. The controller output current 62 is compared with a threshold current value 61. In the event that the comparison reveals that the controller output current 62 is, in fact, higher than the threshold current 61 then the open circuit test reveals no open circuit. This may or may not be indicated to a user. In the event that the comparison reveals that the controller output current 62 is, in fact, lower than the threshold current then the open circuit test has failed (i.e. open circuit is detected). This may or may not be indicated to a user. Where the open circuit test has failed this may be indicated to a user in such a way as to identify that the error is an open circuit error. Where the open circuit test has passed but the controller output current 62 is sufficiently high (possibly by exceeding a second threshold current value) that movement of the valve element 20 would be expected then this may be indicated to a user in such a way as to identify that the error is likely to be a mechanical error such as a stuck valve. This will also allow the user to identify more accurately which component would benefit from further inspection.

While FIG. 1 illustrates two “indicators”, one for an open circuit error and one for no open circuit error, any form of indication (or no indication) may be used. In particular, indication may take the form of one or more electronic logs, one or more simple LED indicators, one or more displays or any other form of indication.

The skilled person will appreciate that, open circuit errors are not only detectable by measuring and/or comparing currents. They may be detected by measuring and/or comparing voltages, impedances etc. In a more general sense, therefore, the disclosure relates to a check which may be performed on an electric signal. The specific embodiment of the disclosure refers to control currents and reference currents but the skilled person will readily appreciate that the disclosure is not limited to currents in favour of other electrical variables. In any case, measuring, for example, a voltage by definition involves detection of the presence and/or absence and/or magnitude of a current. As such, measurement of a voltage necessarily means that a current may in turn be detected via a calculation (even if it is not directly measured). The skilled person would also appreciate that where a check requires a measured current to be below a threshold current, the check may require a measured voltage to be above a threshold voltage.

While an embodiment has been described with reference to an EGR valve in an engine, the skilled person will appreciate that the same method and apparatus may be used in respect of any other DC motor valve in an engine, such as, for example, an inlet throttle valve, a back pressure valve, or a valve which regulates flow of gas to a diesel particulate filter (DPF).

Furthermore, the disclosure is applicable to any valve whether for use in an engine, in any automotive application, or in any other field.

1. A method for monitoring operation of a valve assembly, the valve assembly comprising:
a valve element movable between an open stop and a closed stop wherein a position of the valve element between the open stop and the closed stop establishes the extent to which the valve is open;
a DC motor for moving the valve element in response to an electric signal;
a position sensor for detecting an actual position of the valve element; and
a controller configured to receive data corresponding to a desired position of the valve element and to supply a calculated electric signal to the DC motor in order to effect movement of the valve element from the actual position of the valve element to the desired position of the valve element;
the method comprising the steps of:
measuring the electric signal output from the controller for input to the DC motor when the valve element is stationary;
comparing the measured electric signal output from the controller with a reference electric signal in order to identify a fault.

2. The method of claim 1 further comprising using the position sensor to detect that the movable element is stationary.

3. The method of claim 1 further comprising:
detecting that the movable valve element is stationary in either the fully open condition, wherein the valve element is biased towards the open stop, or the fully closed condition, wherein the valve element is biased towards the closed stop, using the position sensor;
applying an electric signal output from the controller to the DC motor such that the valve element is biased towards the stop associated with its position;
comparing the electric signal output from the controller with the reference electric signal;
wherein an electric signal output from the controller being below the reference electric signal indicates a first type of error corresponding to a controller error.

4. The method of claim 1 further comprising:
using the position sensor to detect that the valve element is stationary at a position between but not including the fully open condition and the fully closed condition;
applying an electric signal output from the controller to the DC motor;
comparing the electric signal output from the controller with the reference electric signal;
wherein an electric signal output from the controller being below the reference electric signal indicates a first type of error corresponding to a controller error, and an electric signal output from the controller being above the reference electric signal indicates a second type of error corresponding to a mechanical fault with the valve or valve element.

5. The method of claim 1 wherein the electric signal output from the controller is a current flow and the reference electric signal is a reference current.

6. The method of claim 5 wherein the reference current is a threshold current.

7. The method of claim 6 wherein the threshold current is 5% of a maximum RMS current receivable by the DC motor in normal use.

8. The method of claim 1 wherein the method is performed at every occasion when the valve element is sensed by the position sensor to be stationary for a predefined period.

9. The method of claim 1 wherein the method is used to monitor operation of a valve assembly in an engine.

10. A controller for monitoring operation of a valve assembly, the valve assembly comprising:
a valve element movable between an open stop and a closed stop wherein a position of the valve element between the open stop and the closed stop establishes the extent to which the valve is open;
a DC motor for moving the valve element in response to an electric signal; and
a position sensor for detecting an actual position of the valve element;
the controller comprising:
an electric signal controller configured to receive data corresponding to a desired position of the valve element and to supply an electric signal for input to the DC motor in order to effect movement of the valve element from the actual position of the valve element to the desired position of the valve element;
a position data receiving portion configured to receive valve element position data from the position sensor and determine that the valve element is stationary;
an electric signal comparator configured to compare the electric signal output from the electric signal controller with a reference electric signal in order to identify a fault; and
an indicator configured to indicate whether the electric signal output from the electric signal controller is above or below the reference electric signal.

11. The controller of claim 10 wherein:
the position data receiving portion is configured to determine when the movable valve element is stationary in either the fully open condition, wherein the valve element is biased towards the open stop, or the fully closed condition, wherein the valve element is biased towards the closed stop, using the position sensor;
the electric signal controller is configured to apply an electric signal to the DC motor such that the valve element is biased towards the stop;
the electric signal comparator is configured to compare the electric signal output from the electric signal controller with a reference electric signal; and
the indicator is configured to output a first type of error corresponding to a controller error if the electric signal controller output signal is below the reference electric signal.

12. The controller of claim 10 wherein:
the position data receiving portion is configured to determine when the movable valve element is stationary at a position between but not including the fully open condition and the fully closed condition;
the electric signal controller is configured to apply an electric signal to the DC motor while the valve element is and remains stationary;
the electric signal comparator is configured to compare the electric signal output from the electric signal controller with a reference electric signal; and
the indicator is configured to output a first type of error corresponding to an electrical error if the electric signal controller output signal is below the reference electric signal and to output a second type of error corresponding to a mechanical fault with the valve element if the electric signal controller output signal is above the reference electric signal.

13. The controller of claim 10 wherein the electric signal output from the controller is a current flow and the reference electric signal is a reference current.

14. The controller of claim 10 wherein the controller is an engine control module.

15. An engine having a valve assembly comprising:
a valve element movable between an open stop and a closed stop wherein a position of the valve element between the open stop and the closed stop establishes the extent to which the valve is open;
a DC motor for moving the valve element in response to an electric signal; and
a position sensor for detecting an actual position of the valve element; and
a controller including: an electric signal controller configured to receive data corresponding to a desired position of the valve element and to supply an electric signal for input to the DC motor in order to effect movement of the valve element from the actual position of the valve element to the desired position of the valve element; a position data receiving portion configured to receive valve element position data from the position sensor and determine that the valve element is stationary; an electric signal comparator configured to compare the electric signal output from the electric signal controller with a reference electric signal in order to identify fault; and an indicator configured to indicate whether the electric signal output from the electric signal controller is above or below the reference electric signal;
wherein the electric signal output from the controller is a current flow and the reference electric signal is a reference current.
